(19) United States
(12) Patent Application Publication
(10) Pub. No.: US 2026/0193843 A1
(43) Pub. Date: Jul. 9, 2026

(54) MULTILAYER METALLIZED PAPER-BASED PACKAGING MATERIAL

(71) Applicant: Société des Produits Nestlé S.A., Vevey (CH)

(72) Inventors: Federico Mora, Morges (CH); Matteo Riccardo Darra, Lausanne (CH)

(73) Assignee: Société des Produits Nestlé S.A., Vevey (CH)

(21) Appl. No.: 19/130,817

(22) PCT Filed: Nov. 20, 2023
(86) PCT No.: PCT/EP2023/082324

§ 371 Date: May 16, 2025

(30) Foreign Application Priority Data
Nov. 23, 2022 (EP) 22209086.2

(51) Int. Cl. D21H 19/82; D21H 19/02; D21H 19/12; D21H 19/20; D21H 19/66; D21H 19/72

(52) U.S. Cl. CPC D21H 19/82; D21H 19/02; D21H 19/12; D21H 19/20; D21H 19/66; D21H 19/72

(57) ABSTRACT

The present invention relates to a cellulosic substrate comprising or consisting of a cellulose graft copolymer comprising polypeptide branches. The present invention also relates to a packaging material comprising at least one paper layer comprising or consisting of a cellulose graft copolymer comprising polypeptide branches, in particular a multi-layer metallized paper-based packaging material.

### FIELD OF THE INVENTION

The present invention relates to a multi-layer paper-based packaging material comprising a paper layer and an ultrathin metal or metalloid layer for water vapour barrier that is sandwiched between ultrathin coating layers that provide oxygen barrier and sealability to the structure. More precisely, it relates to a multi-layer paper-based packaging material wherein the paper layer comprises a cellulose graft copolymer comprising polypeptide branches.

### BACKGROUND OF THE INVENTION

Plastic packaging is used frequently in the economy and in people's daily lives. It has multiple advantages, such as its flexibility and its light weight. Such a weight reduction contributes to fuel saving and CO₂ reduction during transport, for example. Its barrier properties help to reduce food waste due a positive effect on increasing shelf life. The barrier properties also help to secure food safety.

However, with increasing environmental awareness, and in order to ensure that plastic waste is reduced, multilayer packaging materials have been developed which include a paper or cardboard layer, and one or several layers of plastic or metal films, which provide robustness as well as barrier properties, especially to oxygen and moisture.

In the most recent years, environmental awareness increased even further, in particular in relation to waste materials, for instance used packages, that are not recycled or treated properly. This challenge is considered very seriously by industrials who spend increasingly extensive efforts to develop new packaging materials that are rapidly and easily recyclable.

When manufacturing multilayer packaging material structures today, applying a layer of plastic by known techniques, in particular extrusion (extrusion-lamination), or similarly by an adhesive lamination process, necessarily provides a high thickness of the plastic film thus obtained onto the paper.

Even for relatively low thicknesses of extruded or laminated polymers in multilayer structures as described above, the cohesive strength of the polymer film is very high and the level of adhesion of the polymer to the paper or cardboard (i.e. cellulosic) substrate is also high. This prevents such polymer to detach from the substrate when recycled and prevents recycling and repulping of the cellulosic fiber portion in a paper-stream recycling process.

Therefore, later during the recycling process, the multilayer structure comprising a mixture of paper and plastic (polymer) films either extruded (by classic techniques as extrusion-lamination or extrusion coating) or adhesive-laminated, has limited recyclability in standard paper-stream recycling process because the plastic layer is too thick to be dispersed and at the same time the same layer has cohesion strength and adhesion level to the adjacent layers of the structure, which are way too high to be separated from the other layers of materials, especially from the paper fibres. The extruded plastic film remains intact within the paper pulp bath, hence making it difficult to recycle paper pulp from the repulping process.

More than that, the recycling process of known laminated materials described above is expensive, and energy consuming and characterized with relatively low yield of paper fibres that are recycled (below 80% from the total amount of packaging materials in the entire structure), hence, not sufficiently environmentally friendly from a disposal and recycling perspective. There is also room for improving the recyclability of the rest of the packaging material (i.e. the plastic polymer and the metal parts, e.g. aluminium parts) in a paper recycling stream.

Furthermore, for packaging intended for food products, good barrier properties are essential for maintaining the safety and quality of packaged foods. Typically, such barrier properties include gas barrier, for example to oxygen and water vapor (moisture), and if possible, also, liquid tightness.

One way to provide good moisture barrier in paper-based packaging materials, is the introduction of a metal or metalloid layer in a so-called “metallized” layer. In the present description, the word “metallized” (for instance in the expression “metallized barrier paper layer”) is meant to encompass the deposition at the surface of paper or paperboard, of metal or metalloid atoms. One can even consider embodiments comprising the deposition of an alloy of metal and metalloid. Metalloids are close to metals in some of their characteristics. Aluminium oxide and silicon oxide are examples of metalloids.

Problematic with the introduction of a metal layer in paper-based packaging material is the sensitivity of the metal layer to mechanical stress as well as poor adhesion of metal to paper surface, poor smoothness and high porosity of paper materials. Mechanical stress can—for example—easily result in a loss of the required barrier properties that the metallized packaging material should provide. This may be due to the processing of the multilayer material during manufacturing of package using for example a form-fill-seal packaging machine, whereby said material is stretched, bent, rolled, compressed and/or heated during forming and sealing of packages by conventional packaging forming methods. Such packaging manufacturing processes cause high mechanical and or chemical stress to the material and in particular to the ultrathin metallized layer of metal or metalloid, and therefore leads to damaging such layers, creating cracks and tears which are in most cases irreversible.

Having considered the above, there is a need for a multi-layer metallized paper-based packaging material that exhibits simultaneously: sufficient barrier properties, in particular to oxygen and moisture; a high resilience to mechanical stress, such that it keeps the same level of barrier even when subjected to transformation processes such as the ones used for manufacturing packages; a greatly reduced amount of plastic polymer contents compared to the content of cellulosic material; and also preferably recyclability in the paper stream and/or biodegradability in diverse environmental conditions especially (but not only) in a marine environment.

### SUMMARY OF THE INVENTION

The inventors have surprisingly found that by grafting cellulose with polypeptides (e.g. via succinic acid or citric acid), the resilience of a paper layer comprising the cellulose graft copolymer, and hence the mechanical properties of a whole packaging multilayer material comprising the same, is improved.

The inventors have therefore overcome the technical limitations of the known multilayer barrier structures, and achieved a packaging multilayer structure with excellent barrier properties against oxygen and moisture transfer, as well as resistance to liquid contact from their inner or outer surfaces, while achieving a high total content of cellulosic fibres.

Moreover, the fact that the inventors succeeded in forming a multilayer structure completely deprived of polymer layers formed by extrusion lamination and/or adhesive lamination, provides a multilayer structure with a ratio of cellulosic fibre to non-cellulosic material, which is extremely high in fibre contents, and wherein the polymer layers are easy to disintegrate in repulping process due to the solubility of precoating layer in water, and also relatively high adhesion of the post-metallization (or post-metalloidization) polymer to the metallized layer inhibits fragmentation of the metal layer during repulping which results in cleaner fibres from the repulping process. The resulting structure therefore demonstrates excellent repulping capabilities and high fibre yield of good quality which allows it to be accepted in standard recycled paper mills in most countries. The very low content of non-cellulosic polymer and vacuum-deposited metal materials, makes the whole material of the invention easily disintegrated, dissolved and separated during recycling processes designed for cellulosic materials like paper or cardboard, unlike existing multi-layer barrier structures known from the art.

In one aspect, the present invention provides a cellulosic substrate comprising or consisting of a cellulose graft copolymer comprising polypeptide branches. The cellulose graft copolymer may be any described herein. The cellulosic substrate may be a paper substrate, a paperboard substrate, or a cardboard substrate.

In one aspect, the present invention provides packaging material comprising at least one paper layer comprising or consisting of a cellulose graft copolymer comprising polypeptide branches. The cellulose graft copolymer may be any described herein. The packaging material may be a multi-layer metallized paper-based packaging material.

In one embodiment, the present invention provides a multi-layer metallized paper-based packaging material (1) comprising from its outer side to its inner side: (i) a paper layer (2) having a grammage in the range of 30 to 120 g/m², wherein said paper layer comprises or consists of a cellulose graft copolymer comprising polypeptide branches, (ii) at least one organic barrier layer (3) of a polymer selected within the list of: polyvinylalcohol (PVOH), ethylene vinyl alcohol (EVOH), butenediol vinyl alcohol co-polymer (BVOH), or a combination thereof, in an amount of 0.5 to 20 g/m², preferably in an amount of 1 to 10 g/m², more preferably in an amount of 2 to 8 g/m², (iii) at least one inorganic barrier layer (4) selected within the list of: metals, metalloids, or a combination thereof, said inorganic layer having a thickness of 1 to 100 nm, and (iv) at least one organic heat seal layer (5) comprising a heat sealable polymer, said heat seal layer (5) being applied in an amount of 2 to 20 g/m², preferably in an amount of 4 to 9 g/m².

The inorganic layer may comprise metals or metalloids selected within the list of: aluminium, aluminium oxide (AlOx), or silicon oxide (SiOx), said metals and/or metalloids being deposited either by vacuum deposition or transfer metallization. The heat seal layer may comprise an acrylic or methacrylic polymer grafted with at least one ionomer, preferably a sodium ionomer. Suitably, the acrylic or methacrylic polymer grafted with an ionomer has a molecular weight comprised between 85 and 90 g/mol. Each of the organic layer may be deposited to an adjacent layer either by aqueous dispersion, or by aqueous solution deposition.

In some embodiments, the paper layer (2) is covered on its outer surface with an ink layer (6). Suitably, the ink layer is selected within the list of: water-based inks, solvent-less inks, or a combination thereof. In some embodiments, the paper layer or the ink layer is covered on its outer surface by an outermost layer (7) of an over-print varnish (OPV). Suitably, the overprint varnish outermost layer (7) is a styrene acrylic varnish.

The packaging material may have a Water Vapour Transmission Rate (WVTR) below 0.5 g/m²/day (measured at 23° C., 85% Relative Humidity) and/or an Oxygen Transmission Rate (OTR) below 0.1 cm³/m²/day bar (measured at 23° C., 50% RH). The packaging material may have a strain at break under in-plane tensile loading up to 5% in machine direction and up to 15% in the cross-machine direction of the paper.

In one aspect, the present invention provides a tridimensional closed packaging item made of a packaging material according to the present invention, which is obtained by forming, filling with an edible product for human or animal consumption, and then sealing said packaging material.

In one aspect, the present invention provides use of a cellulose graft copolymer comprising polypeptide branches (as described herein), the cellulosic substrate according to the present invention, or the packaging material according to the present invention, for packing an edible product for human or animal consumption.

In one aspect, the present invention provides a packaged edible product, comprising a cellulose graft copolymer comprising polypeptide branches (as described herein), the cellulosic substrate according to the present invention, or the packaging material according to the present invention, filled with an edible product for human or animal consumption.

In one aspect, the present invention provides a cellulose graft copolymer comprising polypeptide branches.

Any suitable polypeptide may be grafted to the cellulose backbone. In some embodiments, the polypeptide is collagen or a hydrolysed form thereof. The polypeptide branches may be coupled to the cellulose by any suitable method. The polypeptide branches may be coupled to the cellulose by a linker. In some embodiments, the polypeptide branches are coupled to the cellulose by a polycarboxylic acid or an anhydride thereof. In some embodiments, the polypeptide branches are coupled to the cellulose by a tricarboxylic acid or an anhydride thereof. In some embodiments, the polypeptide branches are coupled to the cellulose by a tricarboxylic acid selected from one or more of citric acid, isocitric acid, aconitic acid, or tricarballylic acid, or an anhydride thereof. In some embodiments, the polypeptide branches are coupled to the cellulose by citric acid, or an anhydride thereof. In some embodiments, the polypeptide branches are coupled to the cellulose by citric acid. In some embodiments, the polypeptide branches are coupled to the cellulose by a dicarboxylic acid or an anhydride thereof. In some embodiments, the polypeptide branches are coupled to the cellulose by a dicarboxylic acid selected from one or more of malonic acid, succinic acid, glutaric acid, adipic acid, pimelic acid, suberic acid, azelaic acid, or sebacic acid, or an anhydride thereof. In some embodiments, the polypeptide branches are coupled to the cellulose by succinic acid, or an anhydride thereof. In some embodiments, the polypeptide branches are coupled to the cellulose by succinic anhydride.

In one aspect, the present invention provides a method of grafting polypeptides onto cellulose, the method comprising: (a) functionalising cellulose with a linker molecule to provide functionalised cellulose; and (b) grafting polypeptides onto the functionalised cellulose to provide a cellulose graft copolymer comprising polypeptide branches.

Any suitable polypeptide may be used. In some embodiments, the polypeptide is collagen or a hydrolysed form thereof. The cellulose may be functionalised with any suitable linker molecule. In some embodiments, the linker molecule is a polycarboxylic acid or an anhydride thereof. In some embodiments, the linker molecule is a tricarboxylic acid or an anhydride thereof. In some embodiments, the linker molecule is a tricarboxylic acid selected from one or more of citric acid, isocitric acid, aconitic acid, or tricarballylic acid, or an anhydride thereof. In some embodiments, the linker molecule is citric acid, or an anhydride thereof. In some embodiments, the linker molecule is citric acid. In some embodiments, the linker molecule is a dicarboxylic acid or an anhydride thereof. In some embodiments, the linker molecule is a dicarboxylic acid selected from one or more of malonic acid, succinic acid, glutaric acid, adipic acid, pimelic acid, suberic acid, azelaic acid, or sebacic acid, or an anhydride thereof. In some embodiments, the linker molecule is succinic acid, or an anhydride thereof. In some embodiments, the linker molecule is succinic anhydride. Any suitable reaction conditions may be used to functionalise the cellulose. Suitably, the polycarboxylic acid or an anhydride thereof are incubated with a nucleophilic catalyst, optionally wherein the nucleophilic catalyst is 4-Dimethylaminopyridine (DMAP).

Any suitable reaction conditions may be used to graft the polypeptide chains to the cellulose. Suitably, the polypeptide chains are grafted to the functionalised cellulose by a carbodiimide crosslinking reaction. In some embodiments, the carbodiimide crosslinker is 1-ethyl-3-(3-dimethylaminopropyl)carbodiimide hydrochloride (EDAC), optionally wherein N-hydroxysuccinimide (NHS) is included in the carbodiimide crosslinking reaction.

In one aspect, the present invention provides a cellulose graft copolymer obtained by or obtainable by the method according to the present invention.

In one aspect, the present invention provides a functionalised cellulose, wherein the functionalised cellulose is functionalised with a polycarboxylic acid or an anhydride thereof.

In some embodiments, the functionalised cellulose is functionalised with a tricarboxylic acid or an anhydride thereof. In some embodiments, the functionalised cellulose is functionalised with a tricarboxylic acid selected from one or more of citric acid, isocitric acid, aconitic acid, or tricarballylic acid, or an anhydride thereof. In some embodiments, the functionalised cellulose is functionalised with citric acid, or an anhydride thereof. In some embodiments, the functionalised cellulose is functionalised with citric acid. In some embodiments, the functionalised cellulose is functionalised with a dicarboxylic acid or an anhydride thereof. In some embodiments, the functionalised cellulose is functionalised with a dicarboxylic acid selected from one or more of malonic acid, succinic acid, glutaric acid, adipic acid, pimelic acid, suberic acid, azelaic acid, or sebacic acid, or an anhydride thereof. In some embodiments, the functionalised cellulose is functionalised with succinic acid, or an anhydride thereof. In some embodiments, the functionalised cellulose is functionalised with succinic anhydride.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 shows an example reaction scheme for grafting collagen onto cellulose by a two-step coupling using succinic anhydride.

FIG. 2 shows that handsheets formed from the recovered grafted cellulose fiber had improved hydrophobicity. (A) Example photograph showing a water droplet on a small piece of handsheet with and without grafted collagen. (B) Contact angle over time for a handsheet with and without grafted collagen. (C) Rate of change of contact angle for handsheet with and without grafted collagen, for varying volumes of water.

FIG. 3 confirms the presence of the collagen protein in recovered grafted cellulose fiber. (A) SEM image and EDX measurements for dry cellulose fiber. (B-C) SEM image and EDX measurements for wetted cellulose fiber: (B) EDX measurement performed on background; (C) EDX measurement performed on fibers.

FIG. 4 shows an example reaction scheme for grafting collagen onto cellulose by a two-step coupling using citric acid.

FIG. 5 shows a first embodiment of a multilayer structure according to the invention;

FIG. 6 shows a second embodiment of a multilayer structure according to the invention.

### DETAILED DESCRIPTION OF THE INVENTION

Various preferred features and embodiments of the present invention will now be described by way of non-limiting examples. The skilled person will understand that they can combine all features of the invention disclosed herein without departing from the scope of the invention as disclosed.

It must be noted that as used herein and in the appended claims, the singular forms “a”, “an”, and “the” include plural referents unless the context clearly dictates otherwise. The terms “comprising”, “comprises” and “comprised of” as used herein are synonymous with “including”, “includes”, “containing”, or “contains”, and are inclusive or open-ended and do not exclude additional, non-recited members, elements or steps. The terms “comprising”, “comprises” and “comprised of” also include the term “consisting of”. Numeric ranges are inclusive of the numbers defining the range.

All publications mentioned in the specification are herein incorporated by reference. The publications discussed herein are provided solely for their disclosure prior to the filing date of the present application. Nothing herein is to be construed as an admission that such publications constitute prior art to the claims appended hereto.

### Cellulose Graft Copolymer

In one aspect, the present invention provides a graft copolymer comprising a cellulose backbone and polypeptide branches.

As used herein, a “graft copolymer” may refer to a branched copolymer with one or more polymer branches attached to a backbone of a main polymer chain, where the components of the branches are structurally different from that of the main chain (see e.g. Feng, C., et al., 2011. Chemical Society Reviews, 40(3), pp. 1282-1295). The graft copolymer “backbone” may also be referred to as the “main chain” and the graft copolymer “branches” may also be referred to as “side chains” or “pendants”.

### Cellulose Backbone

The graft copolymer of the present invention may be referred to as a cellulose graft copolymer. As used herein, a “cellulose graft copolymer” may refer to a graft copolymer where the main polymer chain is cellulose (see e.g. Kang, H., et al., 2015. Polymer, 70, pp.A1-A16).

Cellulose is a polysaccharide consisting of a linear chain of several hundred to many thousands of β(1→4) linked D-glucose units and may have the following molecular formula:

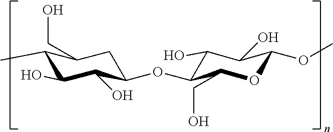

Any suitable source of cellulose may be used in the present invention (see e.g. Lavanya, D. K. P. K., et al., 2011. International Journal of Drug Formulation and Research, 2(6), pp. 19-38). The major industrial source of cellulose is vascular plants. For example, most cellulose used for paper products originates from wood pulp. The molecular weight of cellulose can depend on its sources as well as the extraction conditions for the purification.

The cellulose graft copolymer of the present invention may be in the form of cellulosic fibre, which is generally extracted from plants, seeds or trees; such fibres contain not only cellulose molecules, but also hemi-cellulose as well as lignin.

### Polypeptide Branches

In the graft copolymers of the present invention, the graft polymer branches are polypeptides.

As used herein, a “polypeptide” may refer to may refer to a plurality of amino acid residues linked by peptide bonds. Suitably, a polypeptide is at least about 10 amino acids, at least about 15 amino acids, or at least about 20 amino acids in length. Any suitable polypeptide may be grafted to the backbone. Suitably, the polypeptide is a water-soluble polypeptide. Suitably, the polypeptide is a fibrous polypeptide or a globular polypeptide. Suitable fibrous polypeptides may include collagen. Suitable globular polypeptides may include any type of albumin or globulin. Suitable polypeptides include collagen, ovalbumin, serum albumin, lactoglobulin, or hydrolysed forms thereof. In some embodiments, the polypeptide is selected from one or more of: collagen, ovalbumin, serum albumin, lactoglobulin, or hydrolysed forms thereof. In preferred embodiments, the polypeptide is collagen or a hydrolysed form thereof.

Collagen comprises a right-handed bundle of three parallel, left-handed polyproline II-type (PPII) helices. The tight packing of PPII helices within the triple helix mandates that every third residue be Gly, resulting in a repeating XaaYaaGly sequence, where Xaa and Yaa can be any amino acid. This repeat occurs in all types of collagen. The amino acids in the Xaa and Yaa positions of collagen are often (2S)-proline (Pro, 28%) and (2S,4R)-4-hydroxyproline (Hyp, 38%), respectively. ProHypGly is the most common triplet (10.5%) in collagen (see e.g. Shoulders, M. D. and Raines, R. T., 2009. Annual review of biochemistry, 78, p.929).

Any suitable source of collagen may be used in the present invention (see e.g. Silvipriya, K. S., et al., 2015. Journal of Applied Pharmaceutical Science, 5(3), pp. 123-127). Animal sources include bovine, porcine, and fishes. Collagen is mostly found in connective tissue such as cartilage, bones, tendons, ligaments, and skin.

Any suitable form of hydrolysed collagen may be used in the present invention (see e.g. Mariod, A. A. and Fadul, H., 2013. Acta Scientiarum Polonorum Technologia Alimentaria, 12(2), pp. 135-147). Suitable forms of hydrolysed collagen include gelatin, which is obtained by the thermal denaturation of collagen. In some embodiments, the polypeptide branches are gelatin.

### Linkers

The polypeptide branches may be grafted onto the backbone by any suitable coupling chemistry. Suitably, the polypeptide branches are coupled to the backbone by a linker. Suitably, the graft copolymer comprises the following formula:

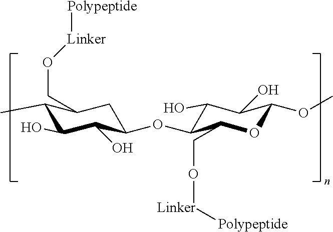

The linker may be any suitable linker, for example any linker described herein. Suitably, the linker may be an aliphatic group (e.g. having from 1 to 8 carbon atoms), optionally substituted with one or more functional groups (e.g. one or more alcohol group, carboxyl group, and/or amide group), optionally coupled to one or more polypeptide, and/or optionally cross-linked to one or more other backbone.

Suitably, the linker is bonded to the backbone by an ester bond (e.g. at the cellulose 6-hydroxyl group) and bonded to the polypeptide by a peptide bond (e.g. at the polypeptide N-terminus). The linker may be derived from a molecule comprising two or more carboxylic acid groups (or an anhydride thereof). In this context, “derived from” may mean that prior to the grafting reaction the linker was a molecule comprising two or more carboxylic acid groups (or an anhydride thereof) and after the grafting reaction one carboxylic acid group forms an ester bond (e.g. at the cellulose 6-hydroxyl group) and one carboxylic acid group forms a peptide bond (e.g. at the polypeptide N-terminus). Suitably, the graft copolymer comprises the following formula:

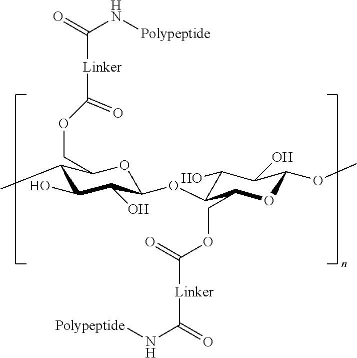

The linker may be an aliphatic group (e.g. having from 1 to 8 carbon atoms), optionally substituted with one or more functional groups (e.g. one or more alcohol group), optionally coupled to one or more polypeptide, and/or optionally cross-linked to one or more other backbone.

Molecules which comprise two or more carboxylic acid groups (or an anhydride thereof) include polycarboxylic acids, or anhydrides thereof. As used herein, a “polycarboxylic acid” may refer to an organic compound containing two or more carboxyl groups (—COOH) and includes dicarboxylic acids and tricarboxylic acids. As used herein, an “acid anhydride” may refer to an organic compound having two acyl groups bonded to the same oxygen atom and a “carboxylic acid anhydride” may refer to an acid anhydride in which the parent acid is a carboxylic acid.

In some embodiments, the linker is derived from a dicarboxylic acid or an anhydride thereof. In some embodiments, the linker is derived from a dicarboxylic acid anhydride. Suitable dicarboxylic acids include malonic acid, succinic acid, glutaric acid, adipic acid, pimelic acid, suberic acid, azelaic acid, sebacic acid, maleic acid, fumaric acid, acetylenedicarboxylic acid, glutaconic acid, muconic acid, glutinic acid, citraconic acid, mesaconic acid and itaconic acid. Suitable dicarboxylic acid anhydrides include malonic anhydride, succinic anhydride, glutaric anhydride, adipic anhydride, pimelic anhydride, suberic anhydride, azelaic anhydride, sebacic anhydride, maleic anhydride, glutaconic anhydride, muconic anhydride, citraconic anhydride, mesaconic anhydride and itaconic anhydride. Suitably, the graft copolymer comprises the following formula:

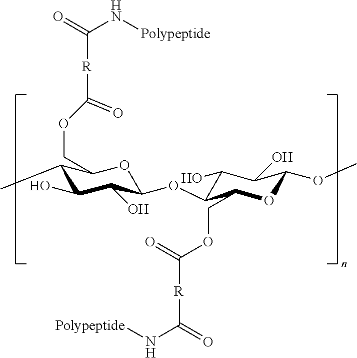

R may be an aliphatic group (e.g. having from 1 to 8 carbon atoms), optionally substituted with one or more functional groups (e.g. one or more alcohol group). In some embodiments, R is an aliphatic group having from 1 to 8 carbon atoms. In some embodiments, R is an aliphatic group having from 2 to 4 carbon atoms. In some embodiments, R is an aliphatic group having from 2 to 3 carbon atoms.

In some embodiments, the linker is derived from succinic acid or an anhydride thereof. In some embodiments, the linker is derived from succinic anhydride. Suitably, the graft copolymer comprises the following formula:

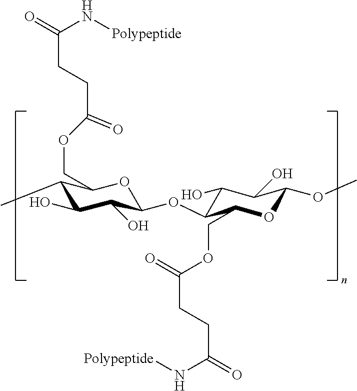

In some embodiments, the linker is derived from a tricarboxylic acid or an anhydride thereof. In some embodiments, the linker is derived from a tricarboxylic acid. Suitable tricarboxylic acids include citric acid, isocitric acid, cis-aconitic acid, trans-aconitic acid and tricarballylic acid. Suitable tricarboxylic acid anhydrides include citric anhydride, citric acid 1,5-anhydride, isocitric anhydride, cis-aconitic anhydride, trans-aconitic anhydride, and tricarballylic anhydride.

Compared to dicarboxylic acids or anhydrides thereof, tricarboxylic acids or anhydrides thereof may have the advantage of allowing additional branching by e.g. (i) coupling to two polypeptides and/or (ii) crosslinking the backbone to other backbones. Suitably, the graft copolymer comprises the following formula:

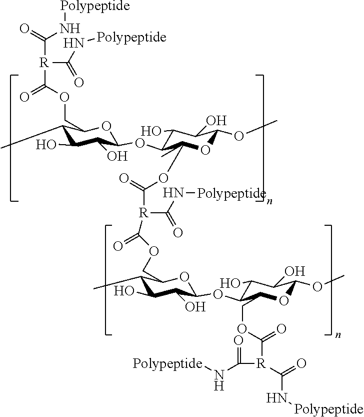

R may be an aliphatic group (e.g. having from 1 to 8 carbon atoms), optionally substituted with one or more functional groups (e.g. one or more alcohol group). In some embodiments, R is an aliphatic group having from 1 to 8 carbon atoms optionally substituted with one or more alcohol group. In some embodiments, R is an aliphatic group having from 3 to 5 carbon atoms optionally substituted with one or more alcohol group. In some embodiments, R is an aliphatic group having from 3 to 4 carbon atoms optionally substituted with one or more alcohol group. In some embodiments, R is an aliphatic group substituted with one alcohol group.

In some embodiments, the linker is derived from citric acid or an anhydride thereof. In some embodiments, the linker is derived from citric acid. Suitably, the graft copolymer comprises the following formula:

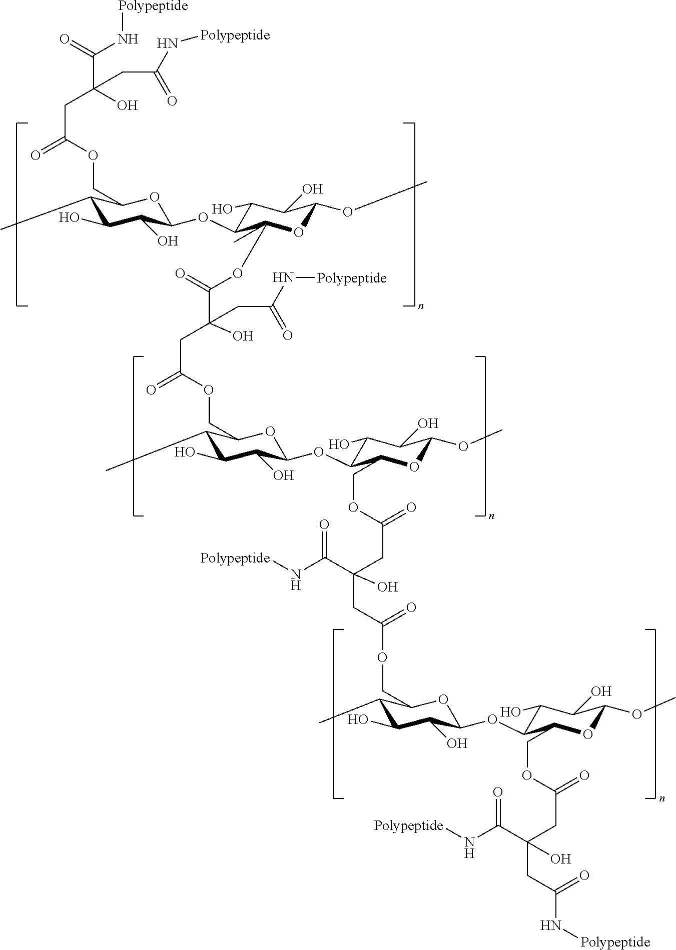

Method of Grafting Polypeptides onto Cellulose

In one aspect, the present invention provides a method of grafting polypeptides onto a cellulose backbone.

The “grafting onto” or “grafting to” method may involve the use of a backbone chain with functional groups that are distributed randomly along the chain. The formation of the graft copolymer originates from the coupling reaction between the functionalised backbone and the end-groups of the branches that are reactive. These coupling reactions can be made possible by modifying the backbone chemically, thereby functionalising the backbone.

The method of the present invention may comprise the steps of: (a) functionalising cellulose; and (b) grafting polypeptides onto the functionalised cellulose. Any suitable reaction conditions may be used to carry out steps (a) and (b). Suitable reaction conditions are described below.

### Step (a): Functionalising Backbone

Any suitable method may be used to functionalise the backbone. For example, step (a) may comprise a step of functionalising the backbone with a linker molecule to provide functionalised backbone. In one aspect, the present invention provides a functionalised backbone obtained or obtainable by step (a). In some embodiments, the functionalised backbone comprises carboxylic acid functional groups.

The linker molecule may be any suitable linker molecule, for example any linker molecule described herein. The linker molecule may comprise two or more carboxylic acid groups (or an be anhydride thereof). Suitably, the functionalised backbone comprises the following formula:

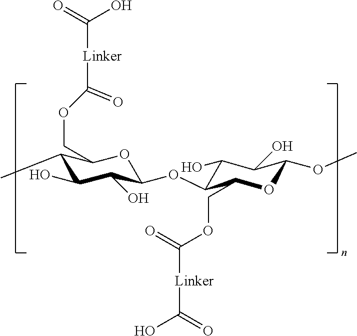

The linker may be an aliphatic group (e.g. having from 1 to 8 carbon atoms), optionally substituted with one or more functional groups (e.g. one or more alcohol group), optionally cross-linked to one or more other backbone.

In some embodiments, the linker molecule is a dicarboxylic acid or an anhydride thereof. In some embodiments, the linker molecule is a dicarboxylic acid anhydride. Suitable dicarboxylic acids include malonic acid, succinic acid, glutaric acid, adipic acid, pimelic acid, suberic acid, azelaic acid, sebacic acid, maleic acid, fumaric acid, acetylenedicarboxylic acid, glutaconic acid, muconic acid, glutinic acid, citraconic acid, mesaconic acid and itaconic acid. Suitable dicarboxylic acid anhydrides include malonic anhydride, succinic anhydride, glutaric anhydride, adipic anhydride, pimelic anhydride, suberic anhydride, azelaic anhydride, sebacic anhydride, maleic anhydride, glutaconic anhydride, muconic anhydride, citraconic anhydride, mesaconic anhydride and itaconic anhydride. Suitably, the functionalised backbone comprises the following formula:

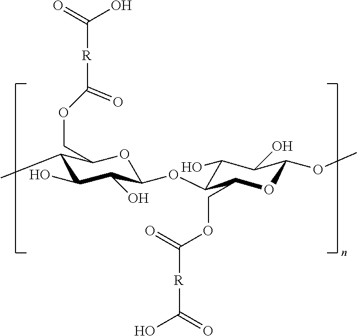

R may be an aliphatic group (e.g. having from 1 to 8 carbon atoms), optionally substituted with one or more functional groups (e.g. one or more alcohol group). In some embodiments, R is an aliphatic group having from 1 to 8 carbon atoms. In some embodiments, R is an aliphatic group having from 2 to 4 carbon atoms. In some embodiments, R is an aliphatic group having from 2 to 3 carbon atoms.

In some embodiments, the linker molecule is succinic acid or an anhydride thereof. In some embodiments, the linker molecule is succinic anhydride. Suitably, the functionalised backbone comprises the following formula:

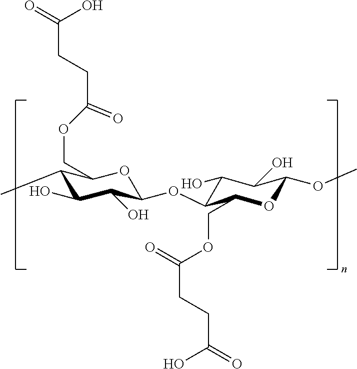

In some embodiments, the linker molecule is a tricarboxylic acid or an anhydride thereof. In some embodiments, the linker molecule is a tricarboxylic acid. Suitable tricarboxylic acids include citric acid, isocitric acid, cis-aconitic acid, trans-aconitic acid and tricarballylic acid. Suitable tricarboxylic acid anhydrides include citric anhydride, citric acid 1,5-anhydride, isocitric anhydride, cis-aconitic anhydride, trans-aconitic anhydride, and tricarballylic anhydride. Suitably, the functionalised backbone comprises the following formula:

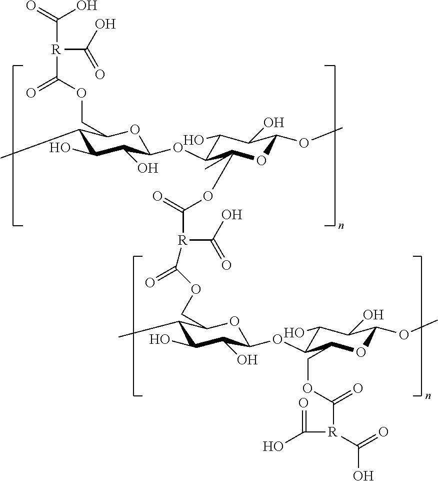

R may be an aliphatic group (e.g. having from 1 to 8 carbon atoms), optionally substituted with one or more functional groups (e.g. one or more alcohol group). In some embodiments, R is an aliphatic group having from 1 to 8 carbon atoms optionally substituted with one or more alcohol group. In some embodiments, R is an aliphatic group having from 3 to 5 carbon atoms optionally substituted with one or more alcohol group. In some embodiments, R is an aliphatic group having from 3 to 4 carbon atoms optionally substituted with one or more alcohol group. In some embodiments, R is an aliphatic group substituted with one alcohol group.

In some embodiments, the linker molecule is citric acid or an anhydride thereof. In some embodiments, the linker molecule is citric acid. Suitably, the functionalised backbone comprises the following formula:

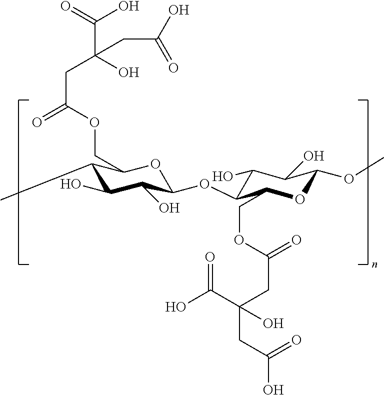

Suitably, the linker molecule may be present in the reaction mixture in amount of at least 0.5 eq, at least 1.0 eq, or at least 1.5 eq. Suitably, the linker molecule may be present in the reaction mixture in amount of 10.0 eq or less, 5.0 eq or less, or 4.0 eq or less. Suitably, the linker molecule may be present in the reaction mixture in amount of from 0.5 eq to 10.0 eq, from 1.0 eq to 5.0 eq, or 1.5 eq to 4.0 eq.

The linker molecule may be coupled to the backbone under any suitable reaction conditions. For example, when the reaction is an esterification reaction, it may be carried out in the presence of a catalyst and heat. Suitably, the reaction mixture comprises a nucleophilic catalyst such as 4-dimethylaminopyridine (DMAP). Suitably, the nucleophilic catalyst (e.g. DMAP) may be added in an amount of 0.1 eq. Suitably, the reaction may be carried out at 95° C. for 24 hours. For example, when the reaction is with a primary alcohol and a dicarboxylic acid, N-hydroxysuccinimide (NHS) or its water-soluble analog Sulfo-NHS can be included to is activate the carboxylic acid group.

Any suitable method known in the art may be used to follow the progress of the reaction and/or to determine that a functionalised backbone has been obtained. Suitably, infrared (IR) spectroscopy, such as Fourier transform infrared (FT-IR) spectroscopy, may be used to determine that a functionalised backbone has been obtained. For example, functionalisation with carboxylic acids may be determined by monitoring the appearance of a carboxylic acid signal at 1650 cm⁻¹. Alternatively, solid state NMR may be used to determine that a functionalised backbone has been obtained.

Step (b): Grafting Polypeptides onto the Functionalised Backbone

Any suitable method may be used to graft the polypeptides onto the functionalised backbone. In one aspect, the present invention provides a graft copolymer obtained or obtainable by step (b).

For example, if the functionalised backbone comprises carboxylic acid functional groups, polypeptides may be grafted to the functionalised backbone by a carboxyl-reactive crosslinking reaction, such as by a carbodiimide crosslinking reaction. Any suitable carbodiimide crosslinker may be used, such as 1-ethyl-3-(3-dimethylaminopropyl)carbodiimide (EDAC) or N,N′-Dicyclohexylcarbodiimide (DCC). EDAC reacts with carboxylic acid groups to form an active O-acylisourea intermediate that is easily displaced by nucleophilic attack from primary amine groups in the reaction mixture. The primary amine forms an amide bond with the original carboxyl group, and an EDAC by-product is released as a soluble urea derivative. Suitably, EDAC may be added to the reaction mixture in an amount of 0.5 eq.

Any suitable reaction conditions may be used. For example, N-hydroxysuccinimide (NHS) or its water-soluble analog Sulfo-NHS can be included in carbodiimide coupling reactions to improve efficiency or create amine-reactive intermediates. EDAC couples NHS to carboxyls, forming an NHS ester that is considerably more stable than the O-acylisourea intermediate while allowing for efficient conjugation to primary amines. Suitably, NHS may be added to the reaction mixture in an amount of 1.5 eq. A base may be added to the reaction mixture, e.g. to deprotonate the carboxylic acid. For example, triethylamine (TEA) may be added to the reaction mixture in an amount of 0.1 eq. Suitably, the reaction may be carried out at 95° C. for 24 hours.

Any suitable method known in the art may be used to follow the progress of the reaction and/or to determine that a graft copolymer has been obtained. Suitably, infrared (IR) spectroscopy, such as Fourier transform infrared (FT-IR) spectroscopy, may be used to determine that a graft copolymer has been obtained. For example, grafting with polypeptides via an amide bond may be determined by monitoring the appearance of amide stretches in the IR spectrum at 1650, 1550 and 1420 cm⁻¹. Alternatively, solid state NMR may be used to determine that a graft copolymer has been obtained. Alternatively, the Kjeldahl method may be used to determine that a graft copolymer comprises polypeptide branches (see e.g. Bradstreet, R. B., 1954. Analytical Chemistry, 26(1), pp. 185-187).

### Cellulosic Substrate

In one aspect, the present invention provides a cellulosic substrate comprising or consisting of the graft copolymer of the present invention or the graft copolymer obtained by or obtainable by the method of the present invention.

As used herein, a “cellulosic substrate” may include any base material comprising cellulose, such as paper, paperboard, cardboard and wood film. Substrate may be used in a converting process such as printing or coating and generally describe the base material onto which, e.g. images, will be printed. Cellulosic substrates may be used to manufacture articles or substances such as packaging materials. In some embodiments, the cellulosic substrate is a paper substrate, a paperboard substrate, or a cardboard substrate.

Suitably, the cellulosic substrate comprises the graft copolymer of the present invention or the graft copolymer obtained by or obtainable by the method of the present invention in an amount of at least 10 weight %, at least 20 weight %, at least 30 weight %, at least 40 weight %, at least 50 weight %, at least 60 weight %, at least 70 weight %, at least 80 weight %, or at least 90 weight %.

### Packaging Material

In one aspect, the present invention provides a packaging material comprising the graft copolymer of the present invention, the graft copolymer obtained by or obtainable by the method of the present invention, or the cellulosic substrate of the present invention.

The packaging material may comprise at least one paper layer comprising or consisting of the graft copolymer of the present invention, the graft copolymer obtained by or obtainable by the method of the present invention, or the cellulosic substrate of the present invention.

As used herein, “packaging material” may refer to any article or substance which is intended to or may come into contact with an edible product for human or animal consumption, including containers such as cartons, boxes, and cases, or wrapping and covering material such as paper and wax paper.

The present invention is further directed to a tridimensional closed packaging item made of a packaging material as described herein (e.g. a multi-layer metallized paper-based packaging material as described herein), which is obtained by forming, then filling with an edible product for human or animal consumption, and then sealing said packaging material.

The present invention is further directed to the use of a packaging material as described herein (e.g. a multi-layer metallized paper-based packaging material as described herein), for packing an edible product for human or animal consumption.

The present invention is further directed to a packaged edible product, comprising a packaging material as described herein (e.g. a multi-layer metallized paper-based packaging material as described herein), which is filled with an edible product for food or animal consumption. Preferably, said edible product is a powder, a gel, or kibbles and is selected within the list of: soluble coffee, nutrition compositions for infant, adult, or elderly consumption, soup, confectionery or candies, chocolate-based products, dry animal food, dairy products.

### Multi-Layer Metallized Paper-Based Packaging Material

In preferred embodiments, the packaging material is a multi-layer metallized paper-based packaging material. A “multi-layer metallized paper-based packaging material” may comprise a paper layer, a pre metallization coating layer, a metallized layer, and a post metallization coating layer.

The paper layer may comprise or consist of the graft copolymer of the present invention, the graft copolymer obtained by or obtainable by the method of the present invention, or the cellulosic substrate of the present invention. Suitably, the paper layer has a grammage in the range of from 30 to 120 g/m². Suitably, the paper layer comprises the graft copolymer of the present invention or the graft copolymer obtained by or obtainable by the method of the present invention in an amount of at least 10 weight %, at least 20 weight %, at least 30 weight %, at least 40 weight %, at least 50 weight %, at least 60 weight %, at least 70 weight %, at least 80 weight %, or at least 90 weight %.

The pre metallization coating layer may comprise or consist of at least one organic barrier layer of a polymer selected within the list of: polyvinylalcohol (PVOH), ethylene vinyl alcohol (EVOH), butenediol vinyl alcohol co-polymer (BVOH), or a combination thereof. The at least one organic barrier layer may be present in an amount of from 0.5 to 20 g/m², preferably in an amount of from 1 to 10 g/m², more preferably in an amount of from 2 to 8 g/m².

The metallized layer may comprise or consist of at least one inorganic barrier layer selected within the list of: metals, metalloids, or a combination thereof. The metallized layer may have a thickness of from 1 to 100 nm. In preferred embodiments, the at least one inorganic barrier layer comprises metals or metalloids selected within the list of: aluminium, aluminium oxide (AlOx), or silicon oxide (SiOx). The metals and/or metalloids may be deposited either by vacuum deposition or transfer metallization. In one particularly preferred embodiment, the at least one inorganic barrier layer is a vacuum-deposited layer of aluminium.

The post metallization coating layer may comprise or consist of at least one organic heat seal layer comprising a heat sealable polymer. The at least one organic heat seal layer may be present in an amount of from 2 to 20 g/m², preferably in an amount of from 4 to 9 g/m².

Each of the organic layers is preferably deposited to an adjacent layer either by aqueous dispersion, or by aqueous solution deposition.

In a preferred embodiment, the multi-layer metallized paper-based packaging material comprises, from its outer side to its inner side:
a paper layer having a grammage comprised in the range of 30 to 120 g/m², wherein said paper layer comprises or consists of a graft copolymer according to the present invention;
at least one organic barrier layer of a polymer selected within the list of: polyvinylalcohol (PVOH), ethylene vinyl alcohol (EVOH), butenediol vinyl alcohol co-polymer (BVOH), or a combination thereof, in an amount of 0.5 to 20 g/m², preferably in an amount of 1 to 10 g/m², more preferably in an amount of 2 to 8 g/m²;
at least one inorganic barrier layer selected within the list of: metals, metalloids, or a combination thereof, said inorganic layer having a thickness comprised in the range of 1 to 100 nm; and
at least one organic heat seal layer comprising a heat sealable polymer, said heat seal layer being applied in an amount comprised in the range of 2 to 20 g/m², preferably in an amount comprised in the range of 4 to 9 g/m².

In all of the embodiments of the invention described herein, the multilayer structure can comprise other additional and optional layers not described in full details therein. Such layers can comprise for instance a print layer on the outer surface of the paper layer, as well as optionally a protective layer that is deposited on the external side of the print layer, and therefore constitutes the outermost layer of the whole structure. Print and optional protective layers are not described in more detail because they are known technology to the skilled person.

In some embodiments, the paper layer is covered on its outer surface with an ink layer. The ink layer may have a thickness of from 0.5 to 5 g/m². In preferred embodiments, the ink layer is selected within the list of: water-based inks, solvent-less inks, or a combination thereof.

More preferably, the paper layer or the ink layer is covered on its outer surface by an outermost layer of an over-print varnish (OPV). The OPV layer may have a grammage of from 0.5 to 10 g/m². The optional OPV layer, when present, can also participate to the improved resistance of the barrier paper to hygroexpansive strain, especially as it provides improved barrier to moisture (water vapour transmission rate or “WVTR”) under high humidity conditions. In an advantageous embodiment, the overprint varnish outermost layer is a styrene acrylic varnish.

The multi-layer metallized paper-based packaging material according to the invention advantageously achieves barrier properties against oxygen and moisture as follows: a Water Vapour Transmission Rate (WVTR) below 0.5 g/m²/day (measured at 23° C., 85% Relative Humidity) and/or an Oxygen Transmission Rate (OTR) below 0.1 cm³/m²/day bar (measured at 23° C., 50% RH). These values are measured after subjecting the sample to an in-plane tensile pre-straining up to 2% and also after subjecting the samples to a Gelboflex testing apparatus in 3 cycles, according to flexibility testing standard ASTM F392 or equivalent.

The multi-layer metallized paper-based packaging material according to the invention preferably has a strain at break under in-plane tensile loading up to 5% in machine direction and up to 15% in the cross-machine direction of the paper. The strain at break of the total paper structure is 2.5% in machine direction and 9% in cross-direction which results into high mechanical resilience.

The multilayer structure according to the invention is preferably designed to qualify for being as well recyclable in a standard recycled paper stream process, according to most regional or national paper recyclability regulations. Recyclability in the paper stream is achieved by a multilayer structure according to the invention wherein:
fibre contents is predominant relatively to all the ingredients contained therein (the definition of recyclability in the paper stream depends on national legislations but in average, it is required that the material contains at least 80% fibre to be accepted in a recycling process dedicated to paper), and
the inorganic layer is ultrathin (i.e. a few nanometres, typically 1 to 100 nm) and its thickness is constituted of a few atoms,
the organic polymer layers are all deposited by aqueous dispersion or aqueous solution deposition coating, which means that the layers thus obtained are sufficiently thin in relation to paper thickness to achieve an extremely high paper contents of the overall structure, which makes the whole structure compatible with paper recycling processes as explained herein,
the organic barrier layer preferably comprises a polymer which is water soluble (i.e. PVOH, EVOH and/or BVOH), which makes it easier to separate the fiber from the rest of the materials of the structure, in particular from the cellulosic contents.

In FIG. 5 is depicted a first embodiment of the invention. In this embodiment, the multilayer structure 1 comprises in order, from its outer side (i.e. the side of the material which is turned towards the outside of the package made thereof) towards its inner side (i.e. the inner side in contact with the packaged product in a package made thereof):
a highly smooth paper layer 2, optionally of grammage 62 g/m², comprising or consisting of the graft copolymer of the present invention, the graft copolymer obtained by or obtainable by the method of the present invention, or the cellulosic substrate of the present invention,
a first organic polyvinyl alcohol-based (PVOH) pre-metallization coating layer 3 that provides mainly gas (especially oxygen) barrier properties and which, optionally, is applied as an aqueous solution in weight of 3 g/m²,
an inorganic vacuum deposited layer 4 of aluminium, optionally, having a thickness of 40 nm, which provides mainly moisture vapour barrier properties, and
a second organic coating layer 5 of methacrylic acid ionomer-based coating which serves as a heat seal layer and which is, optionally, applied as an aqueous dispersion in weight of 5 g/m².

In this first embodiment, the deposition techniques for the first and second organic layers as mentioned above, allow to improve their recyclability in a paper stream process. The structure 1 of this first embodiment can achieve high moisture and gas barrier properties with values of Oxygen Transmission Rate (OTR) below 0.5 cm³/m²/day measured at 23° C. and 50% relative humidity (RH), and water vapour transmission rate (WVTR) below 0.5 g/m²/day measured at 23° C. and 85% RH.

The strain at break of the total structure 1 can be measured as 2.5% in machine direction and 9% in cross-direction %. These values provide excellent resilience properties which allow to protect the aluminium layer during processing of the structure in conventional packaging forming processes. No cracking of the aluminium layer is generated during bending, stretching and/or sealing of the material when manufacturing a package out of it, which results in maintaining the level of OTR and WVTR barrier properties equivalent before and after a package is formed from the multilayer structure material.

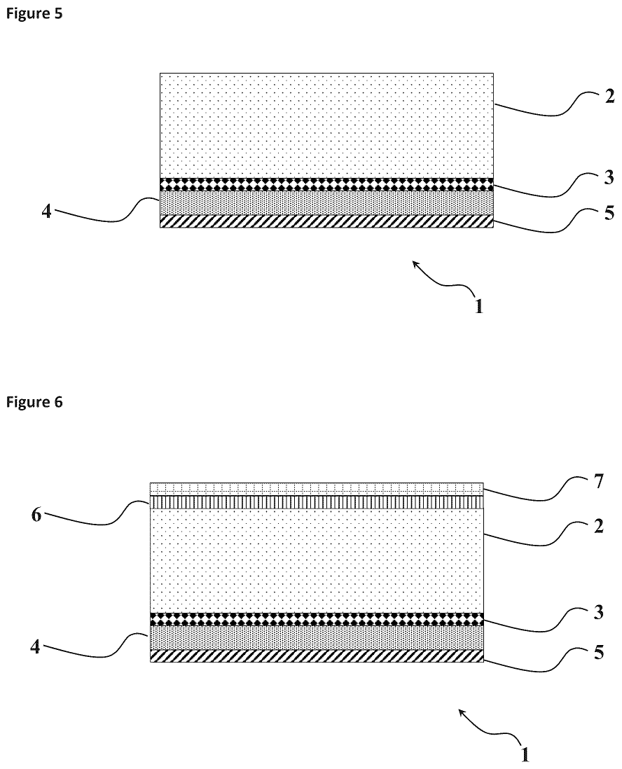

In FIG. 6, is depicted a structure similar to that described above in relation to FIG. 5. However, in this second exemplary embodiment of the invention, the outer surface of the paper layer 2 is covered with two layers as follows, in order from the outside face to the inside of the packaging material:
an outermost acrylic based overprint varnish layer 7, which is optionally applied as an aqueous dispersion in weight of 1 g/m²,
a water-based ink 6 which is optionally applied as an aqueous dispersion in weight of 1 g/m²; this water-based ink layer 6 is located between the outermost overprint varnish layer 7, and the paper layer 2.

The rest of the layers in the structure 1 remain similar to the structure described in reference to FIG. 5, that is to say:
a highly smooth paper layer 2, optionally of grammage 62 g/m², comprising or consisting of the graft copolymer of the present invention, the graft copolymer obtained by or obtainable by the method of the present invention, or the cellulosic substrate of the present invention,
a first organic polyvinyl alcohol-based (PVOH) pre-metallization coating layer 3 that provides mainly gas (esp. oxygen) barrier properties and is optionally applied as an aqueous solution in weight of 3 g/m²,
an inorganic vacuum deposited layer 4 of aluminium optionally having a thickness of 40 nm, which provides mainly moisture vapour barrier properties, and
a second organic coating layer 5 of methacrylic acid ionomer-based coating that is optionally applied as an aqueous dispersion in weight of 5 g/m².

The structures corresponding to the above-described embodiments fulfil the requirements for recyclability of the material or a packaging made thereof, in standard recycled paper mill conditions.

### Method of Manufacturing Multi-Layer Metallized Paper-Based Packaging Material

Generally, in the present specification, “extrusion coating”, it is meant a method to provide a layer of polymer by using an extruder which forces melted thermoplastic resin (e.g. polyethylene) through a horizontal slot-die onto a moving web of substrate (e.g. paper). The resulting product is a permanently coated web structure.

By “extrusion lamination”, it is meant a similar process to extrusion coating, whereby a polymer resin is extruded between two substrates (e.g. a layer of paper and another layer of polymeric film), and acts as a bonding agent.

By “adhesive lamination”, it is meant a process whereby one paper material is coated with adhesive and laminated to a second paper or paperboard material. In a lamination process, two thick layers of material are combined, either by extrusive lamination or adhesive lamination, whereby the thickness of each layer is far greater than the thickness obtained by dispersion coating.

By “dispersion coating”, it is meant a coating technique whereby an aqueous dispersion of fine polymer particles or polymer solution is applied to the surface of paper or board as such, in order to form a solid, non-porous film after drying. Dispersion coating can be performed by gravure, flexo-gravure, rod, blade, slot-die, curtain air knife, roll coating or any other known method of paper coating. Dispersion coating can create a much thinner layer than extrusion lamination and/or adhesive lamination, since the polymer is mixed in an aqueous water solution. This brings advantages in terms of quantity of polymer usage, its barrier performance and recyclability of resulting paper structure. The target of dispersion coating is to achieve a barrier layer against water, water vapour, grease, oil, gas, etc. by environmentally friendly coating. Another target is to prepare surface of paper material for a vacuum deposition process.

### EXAMPLES

The invention will now be further described by way of Examples, which are meant to serve to assist one of ordinary skill in the art in carrying out the invention and are not intended in any way to limit the scope of the invention.

### Example 1: Grafting Collagen onto Cellulose Via Succinic Acid Linker

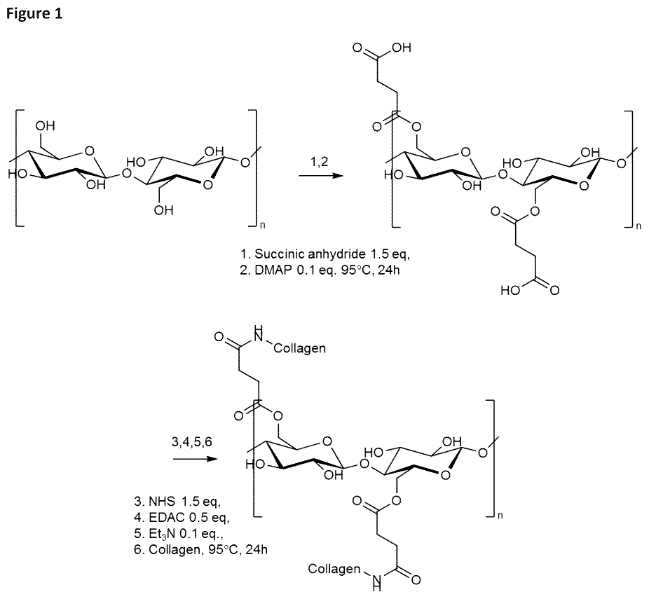

The grafting of collagen is done through a two-step reaction (see reaction scheme in FIG. 1).

The first step involves the functionalisation of cellulose with a carboxylic acid spacer through the grafting of succinic anhydride. 4-Dimethylaminopyridine (DMAP) is used to partially deprotonate the cellulose hydroxyl groups that will then attack the anhydride's carbonyl groups, opening it and releasing the carboxylic acid. The first step of the reaction can be monitored by measuring the IR spectrum and following the increase of the carboxylic acid signal at 1650 cm⁻¹. For completion, the reaction is left overnight. The resulting pulp is filtered and washed thoroughly with water until a neutral pH is obtained.

The carboxylic acid is then activated using a carbodiimide crosslinker, 1-ethyl-3-(3-dimethylaminopropyl)carbodiimide hydrochloride (EDAC), and N-hydroxysuccinimide (NHS) to allow grafting at collagen's N-terminus. The grafting of the collagen is monitored by observing the appearance of the amide stretches in the IR spectrum at 1650, 1550 and 1420 cm⁻¹. The reaction is left overnight, after which the pulp is filtered and thoroughly washed with demineralized water.

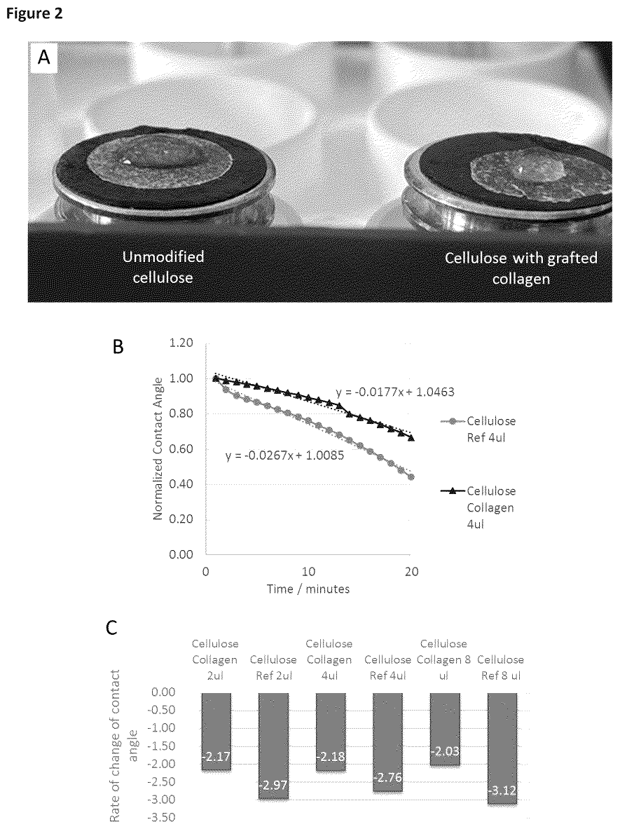

Handsheets were formed from the recovered grafted cellulose fiber. As observed in FIG. 2A, applying a water droplet on a small piece of handsheet with and without grafted collagen showed that in the presence of grafted collagen, the contact angle of the droplet was much larger. This suggests that the hydrophobicity of the handsheet was increased compared to a handsheet without grafted collagen and that the collagen is buffering the absorption of water by the cellulose, thereby creating a more hydrophobic surface. Monitoring of the contact angle over time showed that in the presence of collagen, the adsorption of the water droplet (observed by the decrease in contact angle over time) was slower compared to the reference cellulose (see FIG. 2B). This was confirmed when different volumes of water were applied (see FIG. 2C). Systematically, in the presence of grafted collagen the slope of the contact as a function of time was smaller, suggesting less water adsorption, and hence an increased hydrophobicity of the fiber conferred by the adsorption of the water by collagen and not the cellulose.

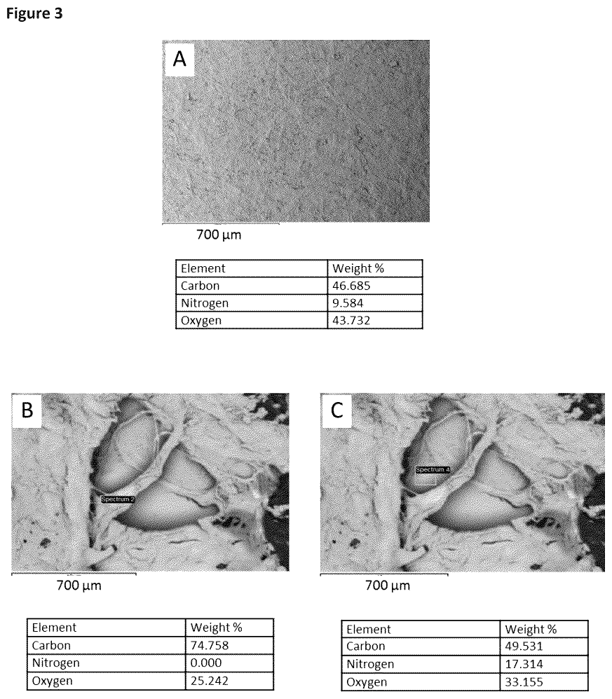

The grafting of collagen to cellulose was further evidenced by EDX measurements (see FIG. 3A). This revealed a higher content of nitrogen compared to the cellulose reference, which confirms the presence of the collagen protein. Addition of a drop of water to the samples lead to a swelling of the samples (see FIG. 3B-C). As can be seen in the SEM images, after wetting a swelling effect was observed on the surface of the sample and when the EDX was performed on clear fibers and on the background it was observed that a higher content of nitrogen emerged, suggesting that the collagen swelled causing the nitrogen content to increase.

### Example 2: Grafting Collagen onto Cellulose Via Citric Acid Linker

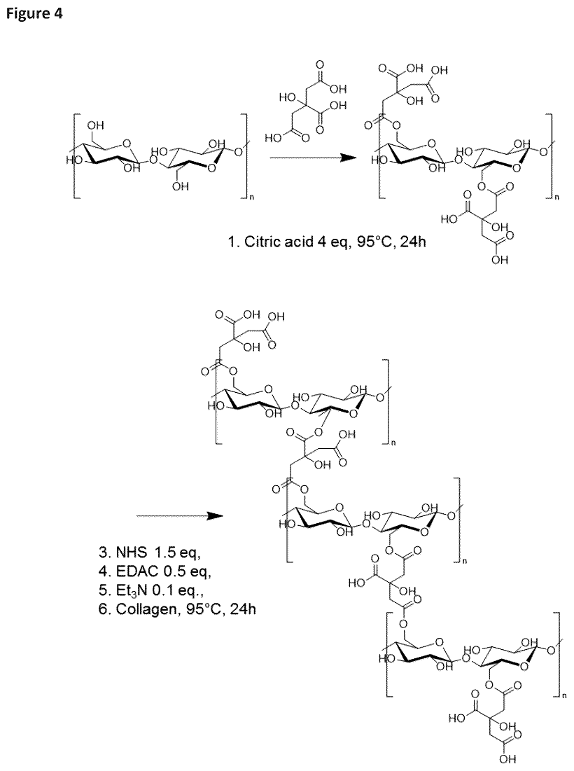

The grafting of collagen to cellulose was also achieved with citric acid (see reaction scheme in FIG. 4). By treating cellulose with 3 equivalents of citric acid (in the presence of DMAP), the increase of the carboxylic acid signal at 1650 cm⁻¹ was monitored by FT-IR, suggesting bond formation. Further reaction with EDAC and NHS to activate the carboxylic acid followed by collagen addition led to an increase in amide signals in FT IR, confirming the grafting of the collagen to the newly formed carboxylic functions.

The citric acid grafted cellulose tended to give a more transparent film compared to the unmodified cellulose. This might be due to the increase crosslinking between cellulose fiber conferred by the citric acid leading to less porosity and less light diffraction, hence a more translucent appearance.

### Embodiments

Various preferred features and embodiments of the present invention will now be described with reference to the following numbered paragraphs (paras).
1. A cellulose graft copolymer comprising polypeptide branches.
2. The cellulose graft copolymer according to para 1, wherein the polypeptide is collagen or a hydrolysed form thereof.
3. The cellulose graft copolymer according to para 1 or 2, wherein the polypeptide branches are coupled to the cellulose by a linker, optionally wherein the cellulose graft copolymer comprises the following formula:

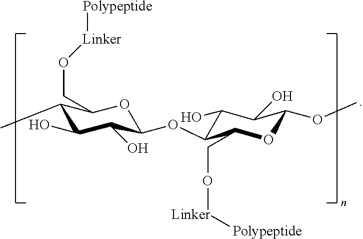

4. The cellulose graft copolymer according to any of paras 1 to 3, wherein the polypeptide branches are coupled to the cellulose by a polycarboxylic acid or an anhydride thereof, optionally wherein the cellulose graft copolymer comprises the following formula:

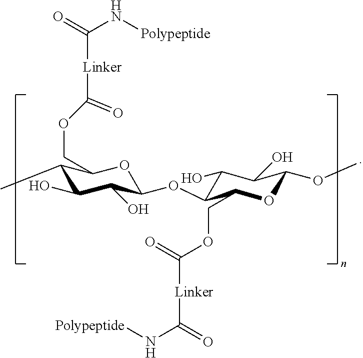

5. The cellulose graft copolymer according to any of paras 1 to 4, wherein the polypeptide branches are coupled to the cellulose by a tricarboxylic acid or an anhydride thereof, optionally wherein the polypeptide branches are coupled to the cellulose by a tricarboxylic acid selected from one or more of citric acid, isocitric acid, aconitic acid, or tricarballylic acid, or an anhydride thereof.
6. The cellulose graft copolymer according to para 5, wherein the polypeptide branches are coupled to the cellulose by citric acid, or an anhydride thereof, preferably wherein the polypeptide branches are coupled to the cellulose by citric acid.
7. The cellulose graft copolymer according to any of paras 1 to 4, wherein the polypeptide branches are coupled to the cellulose by a dicarboxylic acid or an anhydride thereof, optionally wherein the polypeptide branches are coupled to the cellulose by a dicarboxylic acid selected from one or more of malonic acid, succinic acid, glutaric acid, adipic acid, pimelic acid, suberic acid, azelaic acid, or sebacic acid, or an anhydride thereof.
8. The cellulose graft copolymer according to para 7, wherein the polypeptide branches are coupled to the cellulose by succinic acid, or an anhydride thereof, preferably wherein the polypeptide branches are coupled to the cellulose by succinic anhydride.
9. A method of grafting polypeptides onto cellulose, the method comprising:
(a) functionalising cellulose with a linker molecule to provide functionalised cellulose; and
(b) grafting polypeptides onto the functionalised cellulose to provide a cellulose graft copolymer comprising polypeptide branches.
10. The method according to para 9, wherein the polypeptide is collagen or a hydrolysed form thereof.
11. The method according to para 9 or 10, wherein the linker molecule is a polycarboxylic acid or an anhydride thereof, optionally wherein the functionalised cellulose comprises the following formula:

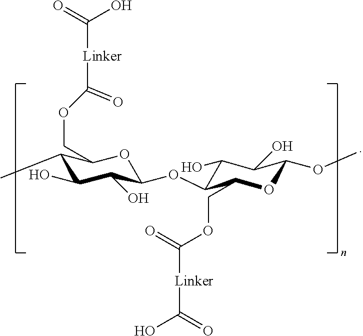

12. The method according to any of paras 9 to 11, wherein the linker molecule is a tricarboxylic acid or an anhydride thereof, optionally wherein the linker molecule is a tricarboxylic acid selected from one or more of citric acid, isocitric acid, aconitic acid, or tricarballylic acid, or an anhydride thereof.
13. The method according to para 12, wherein the linker molecule is citric acid, or an anhydride thereof, preferably wherein the linker molecule is citric acid.
14. The method according to any of paras 9 to 11, wherein the linker molecule is a dicarboxylic acid or an anhydride thereof, optionally wherein the linker molecule is a dicarboxylic acid selected from one or more of malonic acid, succinic acid, glutaric acid, adipic acid, pimelic acid, suberic acid, azelaic acid, or sebacic acid, or an anhydride thereof.
15. The method according to para 14, wherein the linker molecule is succinic acid, or an anhydride thereof, preferably wherein the wherein the linker molecule is succinic anhydride.
16. The method according to any of paras 11 to 15, wherein the polycarboxylic acid or an anhydride thereof are incubated with a nucleophilic catalyst, optionally wherein the nucleophilic catalyst is 4-Dimethylaminopyridine (DMAP).
17. The method according to any of paras 11 to 16, wherein polypeptide chains are grafted to the functionalised cellulose by a carbodiimide crosslinking reaction.
18. The method according to para 17, wherein the carbodiimide crosslinker is 1-ethyl-3-(3-dimethylaminopropyl)carbodiimide hydrochloride (EDAC), optionally wherein N-hydroxysuccinimide (NHS) is included in the carbodiimide crosslinking reaction.
19. A cellulose graft copolymer obtained by or obtainable by the method according to any of paras 9 to 18.
20. A functionalised cellulose, wherein the functionalised cellulose is functionalised with a polycarboxylic acid or an anhydride thereof.
21. The functionalised cellulose according to para 20, wherein the functionalised cellulose is functionalised with a tricarboxylic acid or an anhydride thereof, optionally wherein the functionalised cellulose is functionalised with a tricarboxylic acid selected from one or more of citric acid, isocitric acid, aconitic acid, or tricarballylic acid, or an anhydride thereof, preferably wherein the functionalised cellulose is functionalised with citric acid, or an anhydride thereof, more preferably wherein the functionalised cellulose is functionalised with citric acid.
22. The functionalised cellulose according to para 20, wherein the functionalised cellulose is functionalised with a dicarboxylic acid or an anhydride thereof, optionally wherein the functionalised cellulose is functionalised with a dicarboxylic acid selected from one or more of malonic acid, succinic acid, glutaric acid, adipic acid, pimelic acid, suberic acid, azelaic acid, or sebacic acid, or an anhydride thereof, preferably wherein the functionalised cellulose is functionalised with succinic acid, or an anhydride thereof, more preferably wherein the functionalised cellulose is functionalised with succinic anhydride.
23. A cellulosic substrate comprising or consisting of the cellulose graft copolymer according to any of paras 1 to 8 or para 19.
24. The cellulosic substrate according to para 23, wherein the cellulosic substrate is a paper substrate, a paperboard substrate, or a cardboard substrate.
25. A packaging material comprising the cellulose graft copolymer according to any of paras 1 to 8 or para 19 or the cellulosic substrate according to para 23 or 24.
26. The packaging material according to para 25, wherein the packaging material is a multi-layer metallized paper-based packaging material, preferably wherein the multi-layer metallized paper-based packaging material (1) comprises from its outer side to its inner side:
(i) a paper layer (2) having a grammage in the range of 30 to 120 g/m²,
(ii) at least one organic barrier layer (3) of a polymer selected within the list of: polyvinylalcohol (PVOH), ethylene vinyl alcohol (EVOH), butenediol vinyl alcohol co-polymer (BVOH), or a combination thereof, in an amount of 0.5 to 20 g/m², preferably in an amount of 1 to 10 g/m², more preferably in an amount of 2 to 8 g/m²,
(iii) at least one inorganic barrier layer (4) selected within the list of: metals, metalloids, or a combination thereof, said inorganic layer having a thickness of 1 to 100 nm, and
(iv) at least one organic heat seal layer (5) comprising a heat sealable polymer, said heat seal layer (5) being applied in an amount of 2 to 20 g/m², preferably in an amount of 4 to 9 g/m²,
wherein said paper layer comprises or consists of the cellulose graft copolymer according to any of paras 1 to 8 or para 19 or the cellulosic substrate according to para 23 or 24.
27. The multi-layer metallized paper-based packaging material (1) according to para 26, wherein the inorganic layer comprises metals or metalloids selected within the list of: aluminium, aluminium oxide (AlOx), or silicon oxide (SiOx), said metals and/or metalloids being deposited either by vacuum deposition or transfer metallization.
28. The multi-layer metallized paper-based packaging material (1) according to para 26 or 27, wherein the heat seal layer comprises an acrylic or methacrylic polymer grafted with at least one ionomer, preferably a sodium ionomer.
29. The multi-layer metallized paper-based packaging material (1) according to any of paras 26 to 28, wherein the acrylic or methacrylic polymer grafted with an ionomer has a molecular weight comprised between 85 and 90 g/mol.
30. The multi-layer metallized paper-based packaging material (1) according to any of paras 26 to 29, wherein each of the organic layer is deposited to an adjacent layer either by aqueous dispersion, or by aqueous solution deposition.
31. The multi-layer metallized paper-based packaging material (1) according to any of paras 26 to 30, wherein the paper layer (2) is covered on its outer surface with an ink layer (6).
32. The multi-layer metallized paper-based packaging material (1) according to para 31, wherein the ink layer is selected within the list of: water-based inks, solvent-less inks, or a combination thereof.
33. The multi-layer metallized paper-based packaging material (1) according to para 31 or 32, wherein the paper layer or the ink layer is covered on its outer surface by an outermost layer (7) of an over-print varnish (OPV).
34. The multi-layer metallized paper-based packaging material (1) according to para 33, wherein the overprint varnish outermost layer (7) is a styrene acrylic varnish.
35. The multi-layer metallized paper-based packaging material (1) according to any of paras 26 to 34, wherein the packaging material has a Water Vapour Transmission Rate (WVTR) below 0.5 g/m²/day (measured at 23° C., 85% Relative Humidity) and/or an Oxygen Transmission Rate (OTR) below 0.1 cm³/m²/day bar (measured at 23° C., 50% RH).
36. The multi-layer metallized paper-based packaging material according to any of paras 26 to 35, wherein the packaging material has a strain at break under in-plane tensile loading up to 5% in machine direction and up to 15% in the cross-machine direction of the paper.
37. A tridimensional closed packaging item made of a packaging material according to any of paras 25 to 36, which is obtained by forming, filling with an edible product for human or animal consumption, and then sealing said packaging material.
38. Use of the cellulose graft copolymer according to any of paras 1 to 8 or para 19, the cellulosic substrate according to para 23 or 24, or the packaging material according to any of paras 25 to 36, for packing an edible product for human or animal consumption.
39. A packaged edible product, comprising the cellulose graft copolymer according to any of paras 1 to 7 or para 19, the cellulosic substrate according to para 23 or 24, or the packaging material according to any of paras 25 to 36, filled with an edible product for human or animal consumption.

1. A cellulosic substrate comprising a cellulose graft copolymer comprising polypeptide branches.

2. The cellulosic substrate according to claim 1, wherein the polypeptide is collagen or a hydrolysed form thereof.

3. The cellulosic substrate according to claim 1,
wherein the polypeptide branches are coupled to the cellulose by a linker, optionally
wherein the cellulose graft copolymer comprises the following formula:

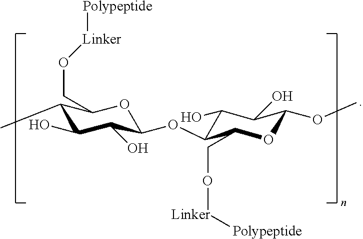

4. The cellulosic substrate according to claim 1,
wherein the polypeptide branches are coupled to the cellulose by a polycarboxylic acid or an anhydride thereof, optionally
wherein the cellulose graft copolymer comprises the following formula:

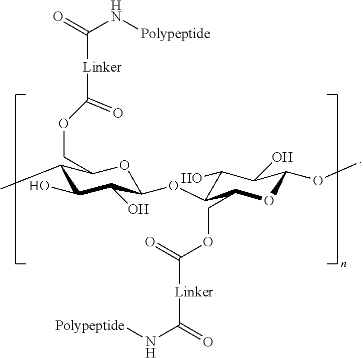

5. The cellulosic substrate according to claim 1, wherein the polypeptide branches are coupled to the cellulose by:
(a) a tricarboxylic acid or an anhydride thereof; optionally wherein the tricarboxylic acid or an anhydride thereof is selected from the group consisting of citric acid, isocitric acid, aconitic acid, tricarballylic acid, an anhydride thereof; and combinations thereof or
(b) a dicarboxylic acid or an anhydride thereof; optionally wherein the dicarboxylic acid or an anhydride thereof is selected from the group consisting of malonic acid, succinic acid, glutaric acid, adipic acid, pimelic acid, suberic acid, azelaic acid, sebacic acid, an anhydride thereof, and combinations thereof.

6. A packaging material comprising the cellulosic substrate according to claim 1.

7. The packaging material according to claim 6, wherein the packaging material is a multi-layer metallized paper-based packaging material comprising from its outer side to its inner side:
(i) a paper layer having a grammage in a range of 30 to 120 g/m², wherein said paper layer comprises the cellulosic substrate,
(ii) at least one organic barrier layer of a polymer selected from the group consisting of polyvinylalcohol (PVOH), ethylene vinyl alcohol (EVOH), butenediol vinyl alcohol co-polymer (BVOH), and combinations thereof, in an amount of 0.5 to 20 g/m²,
(iii) at least one inorganic barrier layer selected from the group consisting of metals, metalloids, and combinations thereof, said inorganic layer having a thickness of 1 to 100 nm, and
(iv) at least one organic heat seal layer comprising a heat sealable polymer, said heat seal layer being applied in an amount comprised in an amount of 2 to 20 g/m².

8. The multi-layer metallized paper-based packaging material according to claim 7, wherein the inorganic barrier layer comprises metals and/or metalloids selected from the group consisting of aluminium, aluminium oxide (AlOx), and silicon oxide (SiOx), said metals and/or metalloids being deposited either by vacuum deposition or transfer metallization.

9. The multi-layer metallized paper-based packaging material according to claim 7,
wherein the organic heat seal layer comprises an acrylic or methacrylic polymer grafted with at least one ionomer, optionally
wherein the acrylic or methacrylic polymer grafted with at least one ionomer has a molecular weight between 85 and 90 g/mol.

10. The multi-layer metallized paper-based packaging material according to claim 7, wherein each of the organic barrier layer layer and the organic heat seal layer is deposited to an adjacent layer either by aqueous dispersion, or by aqueous solution deposition.

11. The multi-layer metallized paper-based packaging material according to claim 7,
wherein the paper layer is covered on its outer surface with an ink layer, wherein the ink layer is selected from the group consisting of water-based inks, solvent-less inks, and combinations thereof, optionally
wherein the paper layer or the ink layer is covered on its outer surface by an outermost layer of an over-print varnish (OPV).

12. The multi-layer metallized paper-based packaging material according to claim 7, wherein the packaging material has:
(a) a Water Vapour Transmission Rate (WVTR) below 0.5 g/m2/day measured at 23° C., 85% Relative Humidity and/or an Oxygen Transmission Rate (OTR) below 0.1 cm3/m2/day bar measured at 23° C., 50% RH; and/or
(b) a strain at break under in-plane tensile loading up to 5% in machine direction and up to 15% in the cross-machine direction of the paper.

13. A tridimensional closed packaging item comprising a packaging material according to claim 6, which is obtained by forming, filling with an edible product for human or animal consumption, and then sealing said packaging material.

14. A method comprising packing an edible product for human or animal consumption in the cellulosic substrate according to claim 1.

15. A packaged edible product, comprising the cellulosic substrate according to claim 1 filled with an edible product for human or animal consumption.

16. A packaged edible product, comprising the packaging material according to claim 6, filled with an edible product for human or animal consumption.
